(19) United States
(12) Patent Application Publication
(10) Pub. No.: US 2024/0286885 A1
(43) Pub. Date: Aug. 29, 2024

(54) DEVICE FOR DRAINING A WASTE WATER TANK COMPRISING A CAP EQUIPPED WITH A PRESSURE BALANCING SYSTEM, AIRCRAFT HAVING AT LEAST ONE SUCH DRAINAGE DEVICE

(71) Applicant: Airbus Canada Limited Partnership, MIRABEL (CA)

(72) Inventors: Marion GOURGUES, MIRABEL (CA); André LALANDE, MIRABEL (CA); Bruno MARCOTTE, MIRABEL (CA)

(21) Appl. No.: 18/431,120

(22) Filed: Feb. 2, 2024

(30) Foreign Application Priority Data
Feb. 28, 2023 (FR) 2301813

(51) Int. Cl. B67D 7/02; B67D 7/36

(52) U.S. Cl. CPC B67D 7/0294; B67D 7/36

(57) ABSTRACT

A drainage device for a tank of an aircraft comprising a drainage duct that has an upstream end, configured to open into the tank, and a downstream end, a drainage valve positioned between the upstream and downstream ends of the drainage duct, a cap configured to occupy a closed position in which it closes off the downstream end of the drainage duct, a pressure balancing system configured to balance the pressures on either side of the cap when the latter is in the closed position. Also an aircraft having at least one such drainage device.

### CROSS-REFERENCES TO RELATED APPLICATIONS

This application claims the benefit of French Patent Application Number 2301813 filed on Feb. 28, 2023, the entire disclosure of which is incorporated herein by way of reference.

### FIELD OF THE INVENTION

The present application relates to a device for draining a waste water tank comprising a cap equipped with a pressure balancing system and to an aircraft having at least one such drainage device.

### BACKGROUND OF THE INVENTION

According to one embodiment, an aircraft comprises at least one tank intended to store waste water, an evacuation system intended to generate a reduced pressure in the tank, and a drainage device configured to drain the tank. This drainage device comprises a drainage duct that has an upstream end opening into the tank and a downstream end, opening outside the fuselage of the aircraft, to which may be connected a discharge duct and a drainage valve positioned between the upstream and downstream ends of the drainage duct and configured to occupy a permissive state in which the drainage valve allows a flow in the drainage duct, from the upstream end towards the downstream end, and a closed state in which the drainage valves prevents any flow in the drainage duct.

Over time, wear of the drainage valve can give rise to a slight leakage of the waste water. In order to prevent any flow at the downstream end of the drainage duct outside of the drainage periods, the drainage device comprises a cap configured to cooperate with the downstream end of the drainage duct and occupy a closed position in which the cap closes off the downstream end of the drainage duct and an open position in which the cap frees up the downstream end of the drainage duct.

During the drainage operations, it can be very difficult for an operator to open the cap.

### SUMMARY OF THE INVENTION

The present invention aims to remedy all or some of the drawbacks of the prior art.

To this end, the invention relates to a drainage device for a tank of an aircraft, comprising:
a drainage duct that has an upstream end, configured to open into the tank, and a downstream end,
a drainage valve positioned between the upstream and downstream ends of the drainage duct,
a cap configured to occupy a closed position in which the cap closes off the downstream end of the drainage duct and an open position in which the cap frees up the downstream end of the drainage duct, the cap separating, in the closed position, an outer zone and an inner zone that is situated in the drainage duct between the drainage valve and the cap in the closed position, the cap having an inner face oriented towards the inner zone and an outer face oriented towards the outer zone.

According to the invention, the drainage device comprises a pressure balancing system having at least one through-orifice connecting the inner and outer faces of the cap and at least one balancing valve supported by the cap and configured to occupy an open state in which the balancing valve allows the inner and outer zones to communicate with each other via the (one or more) through-orifice(s) and a closed state in which the balancing valve prevents the inner and outer zones from communicating with each other.

The balancing system makes it possible to balance the pressures on either side of the cap, and this contributes to making the opening of the cap easier.

According to another feature, the balancing valve is positioned in the inner zone and has a first face oriented towards the inner face of the cap and a second face opposite the first face, the first face being pressed against the inner face of the cap in the closed state.

According to another feature, the cap comprises a hole passing through it. In addition, the balancing valve comprises a rod configured to be housed in the hole, the rod having a section substantially identical to that of the hole, a first end connected to the first face of the balancing valve and a free end opposite the first end.

According to another feature, the hole has an axis substantially perpendicular to the inner face of the cap, the rod being substantially perpendicular to the first face of the balancing valve and centered with respect to this first face.

According to another feature, the rod has a length greater than the thickness of the cap so that the free end of the rod is accessible and able to be actuated from the outer zone.

According to another feature, the balancing valve comprises, at its first face, at least one cutout that forms a cavity between the cap and the balancing valve when the latter is in the closed state.

According to another feature, the drainage device comprises a plurality of through-orifices and a single balancing valve, the through-orifices and the balancing valve being configured and positioned relative to one another in such a way that each through-orifice opens in line with a cutout when the balancing valve is in the closed state.

According to another feature, the cutout forms an annular groove that extends all around the rod.

According to another feature, the cutout is at a distance from the rod such that the first face of the balancing valve forms a shoulder between the cutout and the rod.

According to another feature, the cutout is at a distance from the second face of the balancing valve over the entire circumference of the balancing valve, the first face of the balancing valve forming, between the cutout and the second face, a peripheral edge, which extends over the entire circumference of the balancing valve, configured to be in contact with the inner face of the cap when the balancing valve is in the closed state.

According to another feature, the balancing valve comprises a collar, situated between the cutout and the second face of the balancing valve, which extends as far as the peripheral edge. In addition, the balancing valve is made of a material allowing the collar to deform elastically between a first, non-deformed state, corresponding to the closed state of the balancing valve, in which the peripheral edge is in contact with the inner face of the cap over the entire perimeter of the balancing valve and a second, elastically deformed state, corresponding to the open state of the balancing valve, in which the peripheral edge is spaced apart from the inner face of the cap.

The invention also relates to an aircraft comprising a drainage device according to one of the preceding features.

### BRIEF DESCRIPTION OF THE DRAWINGS

Further features and advantages will become apparent from the following description of the invention, which description is given solely by way of example, with reference to the appended drawings in which:

FIG. 1 is a perspective view of a rear part of an aircraft with a detail view of a zone of the fuselage of the aircraft comprising a drainage device, illustrating one embodiment of the invention,

FIG. 2 is a longitudinal cross section of a drainage device, illustrating one embodiment of the invention,

FIG. 3 is a longitudinal cross section of a pressure balancing system in a closed state, illustrating one embodiment of the invention,

FIG. 4 is a longitudinal cross section of the pressure balancing system visible in FIG. 3, in an open state.

### BRIEF DESCRIPTION OF THE PREFERRED EMBODIMENTS

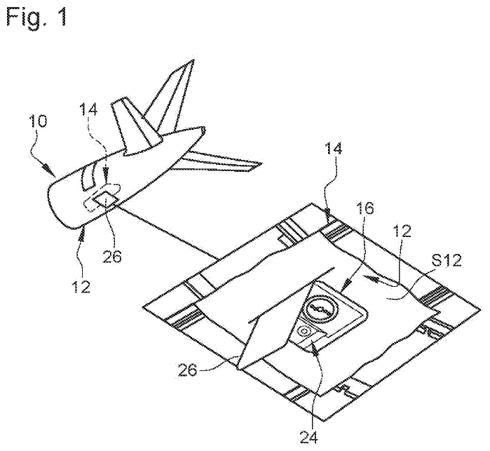

According to an embodiment that is visible in FIG. 1, an aircraft 10 comprises a fuselage 12, at least one tank 14 configured to store waste water and a drainage device 16 configured to make the tank 14 communicate with an outer zone of the fuselage 12.

This drainage device 16 comprises a drainage duct 18 that has an upstream end opening into the tank 14 and a downstream end 18.1 opening outside the fuselage 12, to which can be connected a discharge duct and a drainage valve 20 positioned between the upstream and downstream ends of the drainage duct 18. This drainage valve 20 is configured to occupy an open state in which the drainage valve 20 allows a flow in the drainage duct 18 from the upstream end towards the downstream end, and a closed state in which the drainage valve 20 prevents any flow in the drainage duct 18.

According to one embodiment, the drainage valve 20 has a ball plug and a control 20.1 that is able to be actuated by an operator so as to switch the drainage valve from the closed state to the open state or vice versa.

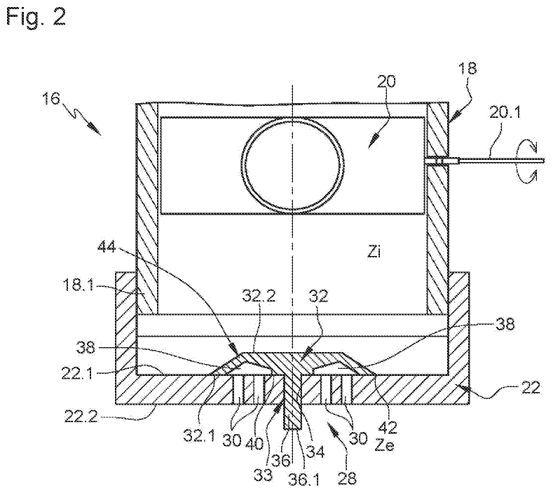

The drainage device 16 comprises a cap 22 configured to cooperate with the downstream end 18.1 of the drainage duct 18 and occupy a closed position (visible in FIG. 2) in which the cap 22 closes off the downstream end 18.1 of the drainage duct 18 and an open position in which the cap 22 frees up the downstream end 18.1 of the drainage duct 18.

The downstream end 18.1 of the drainage duct 18 is configured to removably connect a discharge duct when the cap 22 is in the open position.

According to one configuration, the fuselage 12 comprises an outer surface S12, at least one housing 24, which is recessed with respect to the outer surface S12, and a flap 26 that is able to move between an open position (visible in FIG. 1) in which the flap 26 frees up the housing 24 and a closed position in which the flap 26 closes the housing and has an outer surface in the continuation of the outer surface S12 of the fuselage 12.

The housing 24 is dimensioned so as to house at least the downstream end 18.1 of the drainage duct 18 equipped with the cap 22 and the control 20.1 of the drainage valve 20.

All of these elements are not described further since they may be identical to those of the prior art.

Whatever the embodiment, the cap 22 separates, in the closed position, an outer zone Ze and an inner zone Zi that is situated in the drainage duct 18 between the drainage valve 20 and the cap 22. The cap 22 has an inner face 22.1 oriented towards the inner zone Zi and an outer face 22.2 oriented towards the outer zone Ze, which is substantially parallel to the inner face 22.1. By substantially, it is meant that it is within 10%.

The drainage device 16 comprises a pressure balancing system 28 having at least one through-orifice 30, connecting the inner and outer faces 22.1, 22.2 of the cap 22, and at least one balancing valve 32 supported by the cap 22 and configured to occupy an open state in which the balancing valve 32 allows the inner and outer zones Ze, Zi to communicate with each other via the (one or more) through-orifice(s) 30 and a closed state in which the balancing valve 32 prevents the inner and outer zones Ze, Zi from communicating with each other.

When the cap 22 is in the closed position and the balancing valve 32 is in the open state, the inner and outer zones Ze, Zi communicating with each other, the pressures in these zones Ze, Zi are balanced. Since the pressures are balanced on either side of the cap 22, an operator can easily open it.

According to one configuration, the balancing valve 32 is positioned in the inner zone Zi and pressed against the inner face 22.1 of the cap 22 in the closed state. According to one arrangement, the pressure balancing device 28 comprises a single balancing valve 32 and a plurality of through-orifices 30 cooperating with the balancing valve 32.

The balancing valve 32 has a first face 32.1 oriented towards the inner face 22.1 of the cap 22 and a second face 32.2 oriented towards the inner zone Zi.

According to one configuration, the balancing valve 32 has a frustoconical shape and has a large cylindrical face that corresponds to the first face 32.1 of the balancing valve 32, a small cylindrical face and a lateral face connecting the large and small cylindrical faces, the small cylindrical face and the lateral face corresponding to the second face 32.2 of the balancing valve 32.

The pressure balancing system 28 comprises a connection 33 connecting the balancing valve 32 and the cap 22. According to one embodiment, this connection 33 comprises a hole 34 provided in the cap 22 and a rod 36 as one with the balancing valve 32 and configured to be housed in the hole 34. According to one configuration, the hole 34 is a through-hole, connects the inner and outer faces 22.1, 22.2 of the cap 22 and has an axis substantially perpendicular to the inner face 22.1 of the cap 22. In addition, the rod 36 is substantially perpendicular to the first face 32.1 of the balancing valve 32, centered with respect to this first face 32.1 and has a section substantially identical to that of the hole 34, a first end connected to the first face 32.1 of the balancing valve 32 and a free end 36.1 opposite the first end. The rod 36 and the balancing valve 32 form just a single piece.

According to this configuration, the rod 36 and the balancing valve 32 can move in translation with respect to the cap 22 in a direction substantially perpendicular to the inner face 22.1 of the cap between a first position, corresponding to the closed state of the balancing valve 32, in which the first face 32.1 is in contact with the inner face 22.1 of the cap 22 and a second position, corresponding to the open state of the balancing valve 32, in which the first face 32.1 of the balancing valve 32 is spaced apart from the inner face 22.1 of the cap 22.

According to one arrangement, the rod 36 has a length greater than the thickness of the cap 22 (distance separating the inner and outer faces 22.1, 22.2). Thus, its free end 36.1 is accessible and able to be actuated from the outer zone Ze.

According to another feature, the balancing valve 32 comprises, at its first face 32.1, at least one cutout 38 that forms a cavity between the cap 22 and the balancing valve 32 when the latter is in the closed state. The through-orifices 30 and the balancing valve 32 are configured and positioned relative to one another in such a way that each through-orifice 30 opens in line with a cutout 38 when the balancing valve 32 is in the closed state.

According to one configuration, the cutout 38 extends over the entire circumference of the balancing valve 32, all around the rod 36, and forms an annular groove, which is recessed with respect to the first face 32.1 of the balancing valve 32. In addition, each through-orifice 30 of the cap 22 opens into a zone of the inner face 22.1 of the cap 22 in the form of a ring, said ring being coaxial with the hole 34 and having inner and outer diameters equal to those of the cutout 38.

In the presence of a rod 36 and a cutout 38 in the form of an annular groove, the balancing valve 32 has an umbrella shape.

According to one arrangement, the cutout 38 is at a distance from the rod 36 such that the first face 32.1 of the balancing valve forms a shoulder 40 between the cutout 38 and the rod 36. This shoulder 40 prevents the balancing valve 32 from being pressed over its entire surface against the inner face 22.1 of the cap 22.

The cutout 38 is at a distance from the second face 32.2 of the balancing valve 32 over the entire circumference of the balancing valve 32 such that the first face 32.1 of the balancing valve forms, between the cutout 38 and the second face 32.2 of the balancing valve 32, a peripheral edge 42, which extends over the entire circumference of the balancing valve 32, configured to be in contact with the inner face 22.1 of the cap 22 when the balancing valve 32 is in the closed state.

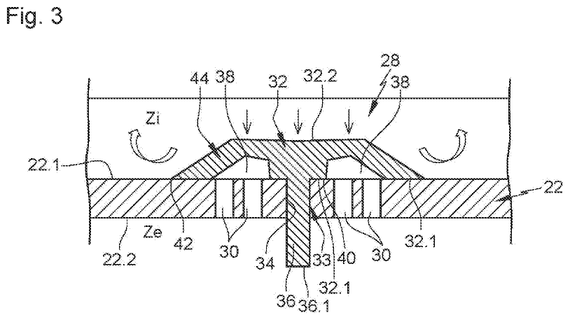

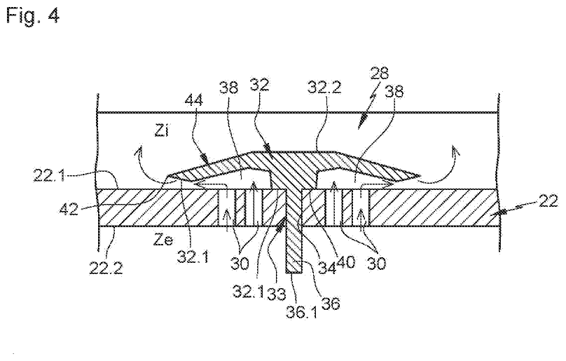

According to one feature, the balancing valve 32 comprises a collar 44, situated between the cutout 38 and the second face 32.2 of the balancing valve 32, which extends as far as the peripheral edge 42. The balancing valve 32 is made of a material allowing the collar 44 to deform elastically between a first, non-deformed state, visible in FIG. 3, corresponding to the closed state of the balancing valve 32, in which the peripheral edge 42 is in contact over the entire perimeter of the balancing valve 32 with the inner face 22.1 of the cap 22 and a second, elastically deformed state, visible in FIG. 4, corresponding to the open state of the balancing valve 32, in which the peripheral edge 42 is spaced apart from the inner face 22.1 of the cap 22.

In operation, when the aircraft is in flight, the pressure in the outer zone Ze is considerably lower than that of the inner zone Zi. Since the outer zone Ze communicates with the cutout 38 via the through-orifices 30, there is a difference in pressure between the inner zone Zi and the cutout 38 that tends to firmly press the balancing valve 32 and more particularly its peripheral edge 42 against the inner face 22.1 of the cap 22, thus reinforcing the seal between the balancing valve 32 and the cap 22, as illustrated in FIG. 3.

When the aircraft is on the ground, the pressure in the zone Ze is greater than or equal to that of the inner zone Zi. Since the outer zone Ze communicates with the cutout 38 via the through-orifices 30, the pressure in the cutout 38 is greater than or equal to that of the inner zone Zi. If the pressures are balanced on either side of the balancing valve 32, the cap 22 can be opened easily. If the pressure in the cutout 38 is higher than that of the inner zone Zi then the peripheral edge 42 of the balancing valve moves away from the cap 22 such that the pressures on either side of the balancing valve 32 are automatically balanced. Since the pressures are now balanced on either side of the cap 22, the latter can easily be opened.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

Claimed is:

1. A drainage device for a tank of an aircraft, comprising:
a drainage duct that has an upstream end configured to open into the tank and a downstream end,
a drainage valve positioned between the upstream end and the downstream end of the drainage duct,
a cap configured to occupy a closed position in which the cap closes off the downstream end of the drainage duct and an open position in which the cap frees up the downstream end of the drainage duct, the cap separating, in the closed position, an outer zone and an inner zone that is situated in the drainage duct between the drainage valve and the cap in the closed position, the cap having an inner face oriented towards the inner zone and an outer face oriented towards the outer zone, and,
a pressure balancing system having at least one through-orifice connecting the inner and outer faces of the cap and at least one balancing valve supported by the cap and configured to occupy an open state in which the at least one balancing valve is configured to allow the inner zone and the outer zone to communicate with each other via the at least one through-orifice and a closed state in which the at least one balancing valve prevents the inner zone and the outer zone from communicating with each other.

2. The drainage device according to claim 1, wherein the at least one balancing valve is positioned in the inner zone and has a first face oriented towards the inner face of the cap and a second face opposite the first face, the first face pressed against the inner face of the cap in the closed state.

3. The drainage device according to claim 2, wherein the cap comprises a hole passing through the cap,
wherein the at least one balancing valve comprises a rod configured to be housed in the hole, the rod having a section substantially identical to that of the hole, a first end connected to the first face of the at least one balancing valve, and a free end opposite the first end.

4. The drainage device according to claim 3, wherein the hole has an axis substantially perpendicular to the inner face of the cap, and
wherein the rod is substantially perpendicular to the first face of the balancing valve and centered with respect to the first face.

5. The drainage device according to claim 3, wherein the cap has a thickness corresponding to a distance separating the inner face and the outer face of the cap, and
wherein the rod has a length greater than the thickness of the cap so that the free end of the rod is accessible and configured to be actuated from the outer zone.

6. The drainage device according to claim 3, wherein the at least one balancing valve comprises, at the first face, at least one cutout that forms a cavity between the cap and the at least one balancing valve when the at least one balancing valve is in the closed state.

7. The drainage device according to claim 6, wherein the drainage device comprises a plurality of through-orifices and a single balancing valve, the plurality of through-orifices and the balancing valve being configured and positioned relative to one another in such a way that each through-orifice opens in line with a cutout when the at least one balancing valve is in the closed state.

8. The drainage device according to claim 6, wherein the cutout forms an annular groove that extends all around the rod.

9. The drainage device according to claim 8, wherein the cutout is at a distance from the rod such that the first face of the at least one balancing valve forms a shoulder between the cutout and the rod.

10. The drainage device according to claim 8, wherein the cutout is at a distance from the second face of the at least one balancing valve over the entire circumference of the at least one balancing valve,
wherein the first face of the at least one balancing valve forms, between the cutout and the second face, a peripheral edge, which extends over an entire circumference of the at least one balancing valve, is configured to be in contact with the inner face of the cap when the at least one balancing valve is in the closed state.

11. The drainage device according to claim 10, wherein the at least one balancing valve comprises a collar, situated between the cutout and the second face of the at least one balancing valve, which extends as far as the peripheral edge, and
wherein the at least one balancing valve is made of a material allowing the collar to deform elastically between a first, non-deformed state, corresponding to the closed state of the at least one balancing valve, in which the peripheral edge is in contact with the inner face of the cap over an entire perimeter of the at least one balancing valve, and a second, elastically deformed state, corresponding to the open state of the at least one balancing valve, in which the peripheral edge is spaced apart from the inner face of the cap.

12. An aircraft comprising:
the drainage device according to claim 1.
